(19) United States
(12) Patent Application Publication
(10) Pub. No.: US 2023/0328847 A1
(43) Pub. Date: Oct. 12, 2023

(54) FLEXIBLE HEATING ELEMENT, METHOD FOR PRODUCING SUCH A HEATING ELEMENT, AND USE OF A FLEXIBLE HEATING ELEMENT

(71) Applicant: Heraeus Nexensos GmbH, KLEINOSTHEIM (DE)

(72) Inventors: Tim ASMUS, Kleinostheim (DE); Matthias MUZIOL, Kleinostheim (DE); Christoph NICK, Kleinostheim (DE); Stefan DIETMANN, Kleinostheim (DE); Karlheinz WIENAND, Kleinostheim (DE); Carsten NEEMANN, Kleinostheim (DE)

(21) Appl. No.: 18/042,465

(22) PCT Filed: Aug. 20, 2021
(86) PCT No.: PCT/EP2021/073136

§ 371 Date: Feb. 22, 2023

(30) Foreign Application Priority Data
Aug. 27, 2020 (EP) 20193026.0
Feb. 19, 2021 (DE) 10 2021 104 002.7

(51) Int. Cl. H05B 3/34; A24F 40/46

(52) U.S. Cl. CPC H05B 3/34; A24F 40/46; H05B 2203/011

(57) ABSTRACT

The invention relates to a flexible heating element exhibiting a temperature resistance of at least 250° C., in particular of at least 300° C., comprising an electrically conductive substrate formed from a metal foil, an insulation layer formed on at least one side of the substrate, and a heating structure formed on the side of the insulation layer facing away from the substrate, wherein the heating element has a heating-element thickness of less than 1.0 mm, the substrate has a substrate thickness of 0.02 mm-0.5 mm, and the insulation layer has an insulation-layer thickness of 0.2 μm-30 μm.

The invention relates to a flexible heating element exhibiting a temperature resistance of at least 250° C., in particular of at least 300° C. Furthermore, the invention relates to a method for producing such a heating element. The invention also relates to the use of a flexible heating element according to the invention.

Different embodiments of heating elements are known from the prior art. US 2018/0093455 A1, for example, discloses a flexible, flat heater which is formed on the basis of a polymer laminate. The laminate consists of a polymer layer, specifically of polyimide, of a primer layer and of a silicone adhesive layer. A metal structure, which is formed as a heating structure, is laminated onto the silicone adhesive layer. However, a disadvantage of such heating elements is the use of a polymer laminate. Use of such materials prevents the use of the heating element at temperatures above 300° C. This is due to the fact that the polymers of the laminate would be pyrolyzed or degraded at such temperatures.

U.S. Pat. No. 5,408,574 A in turn discloses a heating element based on the use of a ceramic substrate. The ceramic substrate has a thickness of 25-250 μm in order to guarantee sufficient robustness. The heater comprises individual heating structures which can be controlled individually. These heating structures are preferably produced by means of screen printing on the basis of a paste containing noble metal. A heating element of this kind is designed such that, at a maximum heating power of 10-20 W, it reaches a temperature of 450° C.-600° C. in two seconds. However, in the case of such a heating element the use of a ceramic substrate is disadvantageous. Such ceramic substrates are neither elastic nor have a high breaking strength.

Proceeding from the above, it is an object of the present invention to specify such a solution, which comprises, on the one hand, a heating element that is flexible and, on the other hand, has a high temperature resistance. Flexible design of a heating element is particularly advantageous in order to form a good thermal contact with bodies in contact which have uneven surfaces.

Furthermore, the object of the present invention is to specify a method by means of which a flexible heating element can be produced. A further object of the invention is to specify a corresponding use of the heating element according to the invention.

According to the invention, this object is achieved with regard to a flexible heating element by the subject matter of claim 1, with regard to a method for producing a heating element according to the invention by the subject matter of claim 11 and with regard to the use of a heating element according to the invention by the subject matter of claim 15.

The invention is based on the idea of specifying a flexible heating element having a temperature resistance of at least 250° C., in particular of at least 300° C., the flexible heating element comprising:
an electrically conductive substrate formed from a metal foil,
an insulation layer formed on at least one side of the substrate, and
a heating structure formed on the side of the insulation layer facing away from the substrate,

wherein the heating element has a heating element thickness of less than 1.0 mm, the substrate has a substrate thickness of 0.02 mm-0.5 mm, and the insulation layer has an insulation layer thickness of 0.2 μm-30 μm.

In other words, a heating element is specified which, on the one hand, is flexible and, on the other hand, exhibits a high temperature resistance of at least 250° C., in particular of at least 300° C. The formation of such a heating element is made possible by the individual layers or components of the flexible heating element being further developed with respect to their materials and the respective thicknesses of the elements or layers in such a way that, on the one hand, flexibility is produced and, on the other hand, temperature resistance is formed.

In a particularly preferred embodiment of the invention, the heating element has a heating element thickness of less than 0.6 mm, particularly preferably of less than 300 μm.

Particularly suitable insulating layers are such electrically insulating layers that electrically separate the electrically conductive substrate from the heating structure. In general, layers exhibiting a specific resistance of >10E10 Ω*cm are suitable for this purpose.

The insulation layer preferably comprises a metal oxide layer, in particular an anodized metal oxide layer, or a metal nitride layer or a metal oxide nitride layer. In a particularly preferred embodiment of the invention, the insulation layer is a metal oxide layer, in particular an anodized metal oxide layer, or a metal nitride layer or a metal oxide nitride layer. If the insulation layer is one of the aforementioned metal layers, the insulation layer will not have any further layers that come under the preceding layer definitions.

Furthermore, it is possible for the insulation layer to be designed as a combination of different stacked metal oxide layers, metal nitride layers or metal oxide nitride layers.

The advantage of an insulation layer which is or has a metal oxide layer, a metal nitride layer or a metal oxide nitride layer is that such insulation layers not only exhibit good insulating properties but can also be designed as thin as possible.

Some metals, such as aluminum or FeCrAl alloys, form particularly stable metal oxide layers so that flaking of the insulating layer or the formation of cracks in the insulation layer is prevented, even in the case of rapid changes in temperature.

Furthermore, it is possible for the insulation layer to comprise the following components:

aluminum oxide (Al₂O₃) and/or aluminum titanate (Al₂TiO₅) and/or titanium dioxide (TiO₂) and/or silicon dioxide (SiO₂) and/or silicon oxide (SiO) and/or magnesium oxide (MgO) and/or magnesium titanate (MgTiO₃) and/or a binary zirconium dioxide alloy and/or a ternary zirconium dioxide alloy and/or boron nitride (BN) and/or aluminum nitride (AlN) and/or silicon nitride (Si₃N₄).

In a further embodiment of the invention, it is possible for the insulation layer to be produced by means of the aerosol deposition method (ADM). With the aid of such a method, ceramic or glass-like insulation layers can be produced. These layers have a particularly high electrical insulation and can additionally have a thin layer thickness. If the insulation layer is produced by means of the ADM method, the insulation layer thickness can be 0.2 μm-10 μm.

In addition to the ADM method, other known deposition methods such as CVD (chemical vapor deposition) or CSD (chemical solution deposition) or PVD (physical vapor deposition) for applying an insulation layer to a metal foil are also possible.

The electrically conductive substrate is formed from a metal foil. In particular, the electrically conductive substrate consists of a metal foil.

The metal foil is preferably formed from such materials which form dense metal oxide layers exhibiting a high electrical insulation during an anionic oxidation. This helps with producing a corresponding insulating layer. In particular, foils made of aluminum, steel, titanium, niobium or tantalum are suitable as metal foils. With regard to steel foils, alloys containing chromium and aluminum are suitable in particular.

The metal foil is preferably formed from aluminum (Al) and/or steel and/or titanium (Ti) and/or niobium (Nb) and/or tantalum (Ta) or alloys thereof.

The steel is preferably a FeCrAl alloy, in particular X8CRAl20-5 or FeCr25Al5.

The substrate thickness is 0.02 mm-0.5 mm, in particular 0.05 mm-0.3 mm.

Because metal foils are used to produce an electrically conductive substrate, in particular when an aluminum foil is used, warpage of the metal foil during the heating-up of the flexible heating element is prevented.

The use of a metal foil for forming an electrically conductive substrate furthermore has the advantage that in contrast to the use of polymer substrates, for example, the insulation layer can be applied by means of variable methods.

Because the metal foil can be exposed to high temperatures, the insulation layer can also be applied by means of such methods which are accompanied by a high temperature loading. This is the case, for example, when applying pastes containing metal. Such pastes or sinter paste layers normally need to be sintered at high temperatures of, for example, 1,000° C. Since a metal foil is used, such temperature loadings can readily be provided.

An anodized metal oxide layer differs from an atmospheric metal oxide layer in having a higher electrical insulation. An anodized metal oxide layer can be produced, for example, by anodizing a metal surface. In other words, an insulation layer which is an anodized metal oxide layer can be produced by anodizing the metal surface of the substrate. Due to electrolytic oxidation, the surface of the metal foil is converted into a metal oxide layer.

A further advantage of forming an insulation layer based on a thermally or anodically oxidized substrate relates to the connection of the insulation layer to the substrate. An insulation layer produced or provided in this way has an increased connection to the substrate than is the case, for example, by means of subsequently applied ceramic layers. Thermally oxidized, in particular anodized, substrates can also be mechanically processed, in particular punched, after the thermal oxidation method is carried out, in particular after an anodizing method is carried out. During this mechanical processing, in particular during punching, the insulation layer is not damaged further. Instead, the insulation layer is prevented from flaking off in this case.

An anodizing method is a method in surface technology for producing an oxidic protective layer by anodic oxidation. In contrast to galvanic coating methods, the protective layer is not deposited on the workpiece, but instead an oxide or hydroxide is formed by converting the uppermost metal layer. A layer of 5 μm-25 μm is produced, which protects and isolates underlying layers or elements, namely the substrate.

A further possibility for producing a metal oxide layer is a hard anodizing method. Here, the metal foil is immersed in an electrolyte as in the case of the eloxal method and is connected as an anode. The surface of the metal foil is thereby oxidized so that a metal oxide layer forms. In this case, a volume increase in the metal foil takes place.

Appropriate selection of the material of the metal foil of the electrically conductive substrate enables a corresponding selection with regard to the insulation layer to be formed thereon.

Before the oxidation of the metal surface, pre-treatment steps of the surface can be carried out, such as etching, pickling, honing, electropolishing, mechanical polishing, sandblasting, particle blasting or grinding. In addition, a combination of a plurality of the aforementioned pre-treatment steps is possible.

When a steel foil made of a FeCrAl alloy is used, oxidation of this layer in air at an elevated temperature can also produce a metal oxide layer.

When a FeCrAl alloy with an aluminum content of 6% is used, for example, an electrically insulating layer, in particular an electrically insulating aluminum oxide layer of up to 5 μm can be produced in an oxygen-containing atmosphere in an oven at oxidation temperatures of 1,000° C. to 1,100° C.

In a further embodiment of the invention, it is also possible for steel foils with a low CrAl content to be used, provided such a steel foil is alitized on at least one surface or on at least one side. An alitizing method involves an aluminum-containing layer being applied to the substrate metal foil, whereby this aluminum-containing layer is subsequently annealed at temperatures of 800° C. to 1,200° C. This produces dense Al₂O₃ layers with a thickness of >20 μm. The Al₂O₃ layer is present in the α-phase. On the basis of this method, an insulation layer is formed on at least one side of the substrate. Such an insulation layer is an electrically insulating metal oxide layer.

A flexible heating element is to be understood in particular as a heating element that can be deflected in a direction perpendicular to a front side or a rear side without the deflection leading to a significant change in resistance and/or to cracks and/or fractures and/or similar damage to the heating element. Heating even in the bent state is expressly possible.

The flexibility of the heating element is defined as a reversible deflection of a front side or a rear side of the heating element at a bending radius of at least 30 mm, in particular of at least 25 mm, in particular of at least 20 mm, in particular of at least 10 mm, in particular of at least 0.5 mm.

Reversibility also means that an already deformed metal foil additionally still has a spring effect. After a forced additional bending of the metal foil, it returns completely or at least partially back to its predefined initial position. As a result of the spring action, a bent heating element can automatically exert a force on surrounding parts after its installation in a holder and thus fits snugly against it.

The at least one heating structure is preferably applied directly to the insulation layer. In other words, the at least one heating structure is applied directly to the side of the insulation layer facing away from the substrate. In such an embodiment of the invention, no further layers are formed between the heating structure and the side of the insulation layer facing away from the substrate.

In a preferred embodiment of the invention, the heating structure is not directly in contact with the substrate. In other words, the heating structure is completely electrically separated from the substrate by means of the formation of the insulation layer. The heating structure is preferably not in contact with the electrically conductive substrate.

However, embodiments are also possible in which adhesion promoter layers, such as titanium/titanium oxide or tantalum/tantalum oxide layers, are formed between the insulation layer and the heating structure.

The heating structure preferably consists of a metal structure. The heating structure preferably has an electrical resistance of 0.5 to 30.0Ω, in particular 0.5 to 10.0Ω. The electrical resistance is formed between two terminals of the heating structure.

The heating structure describes a structured element which triggers the actual heating process of the flexible heating element.

The heating structure, which is produced in particular from a metal structure, can have any shape. For example, forming a heating structure in a square shape is possible. Forming a heating structure with a substantially straight-line structure is also possible.

In particular, the heating structure has a meandering shape. Such a meandering shape can be formed, for example, from a continuous, interwoven and/or nested and/or intermeshed line structure. The individual portions, in particular the individual line portions, can be made relatively thin.

The heating structure, which is present in particular in a meandering shape, can cover an area of any desired size due to the structure formed. Such a large area of the object to be heated leads to a homogeneously produced surface temperature.

The heating structure can be formed from a structured metal foil. If such a design is present as regards the heating structure, the heating structure may be produced in a separate process and subsequently applied to the insulating layer.

In a further embodiment of the invention, the heating structure, which is preferably formed from a structured metal foil, can be floated onto the insulation layer and affixed to the insulation layer.

Furthermore, it is possible for the heating structure to be produced from a paste containing metal and/or an ink containing metal. Such a paste and/or ink containing metal can be applied to the insulation layer in the context of printing, in particular in the context of a screen printing method.

In a particularly preferred embodiment of the invention, the heating structure is produced from a paste containing a noble metal. In particular, the noble metals may be platinum and/or silver and/or gold.

In a further embodiment of the invention, the heating structure is a metal structure produced by means of thin-foil metal deposition.

Preferably, the at least one heating structure comprises at least two contact pads or is connected to at least two contact pads. Preferably, the at least two contact pads are formed on the side of the insulation layer facing away from the substrate.

If the heating structure of the flexible heating element does not comprise any contact pads, the heating structure will comprise at least two connections, which are each electrically connected to the outside.

In a further embodiment of the invention, a passivation layer can be formed at least in portions on the heating structure, i.e., on the side of the heating structure facing away from the substrate. Such a passivation layer is preferably a glass and/or ceramic layer. It is possible for the passivation layer to comprise polymer materials, in particular cross-linked polymers.

In one possible embodiment of the invention, the passivation layer is produced by means of the aerosol deposition method (ADM).

Furthermore, it is possible for the flexible heating element to be surrounded completely by a passivation layer, in particular by an electrically insulating glass and/or ceramic layer, or be encapsulated in such a layer. In such an embodiment of the invention, the contact pads and/or connections of the heating structure are to be left free of such a passivation layer at least in portions. In other words, at least the two contact pads and/or at least two terminals of the heating structure are not completely coated with a passivation layer.

In a further embodiment of the invention, the heating structure can be formed between two substrate portions, wherein the two substrate portions are formed by folding the substrate. Such an embodiment of the invention enables good heat transfer between the heating structure and the substrate.

Furthermore, it is possible for the heating structure to be formed between two substrate portions, wherein the substrate portions are formed separately from one another. In other words, the heating structure can be formed between two separate substrate portions in such a way that a sandwich structure is formed. Such a formation of a heating structure formed between two substrate portions is possible in particular when using in particular surface-oxidized metal foils as a substrate. A connection of the substrate parts can also be produced by roll-bonding or laser welding. The internal heating structure can also be held and pressed by a tensioning of at least two substrate parts against one another. Such embodiments of the invention enable good heat transfer between the heating structure and the substrate.

In a further embodiment of the invention, the substrate portions can be designed differently. This relates, for example, to the materials of the substrate portions. It is possible for differently oxidized metal foils to form two different substrate portions. In such an embodiment of the invention, the flexible heating element can be specified and adapted specifically to each installation situation or with respect to the specific field of application.

If a heating structure is formed between two separate substrate portions, two insulating layer portions will also be formed. The insulating layer portions are formed separately from one another or are formed by folding a single insulation layer. In other words, the heating structure is formed between two insulation layer portions, whereby the insulation layer portions are in turn formed between two substrate portions.

It is possible for the insulation layer portions to be welded, in particular spot-welded, to the substrate portions.

The flexible heating element according to the invention exhibiting a temperature resistance of at least 250° C. has a flat design due to the material selection according to the invention and the layer thickness selection according to the invention. Such a flat design enables the use of the flexible heating element in structurally limited applications.

With the aid of the flexible heating element according to the invention, it is possible to form larger surfaces, i.e., larger front and/or rear sides of the flexible heating element, compared to heating elements of the prior art. Due to such large surfaces or large front and/or rear sides, good heat transfer from the flexible heating element to an object to be heated is possible.

In one possible embodiment of the invention, the flexible heating element is not designed flat. The flexible heating element can be bent, for example.

In one possible embodiment, the flexible heating element is bent into a hollow body. In other words, the flexible heating element has the shape of a hollow body, in particular the shape of a cylinder.

If the flexible heating element is designed as a hollow body, in particular in the shape of a cylinder, the hollow body has a round cross section. The cross section is preferably at least 2 mm, in particular at least 3 mm. With the aid of the flexible heating element, it is therefore possible to provide such a heating element which can be positioned in small components. In particular, it is possible to use a flexible heating element according to the invention in an electrical smoking device.

In order to form a flexible heating element in the hollow body, in particular in cylindrical form, two side edges of the substrate are bent toward one another, for example. The side edges that are then facing one another can be arranged, for example, in abutment with one another.

Furthermore, it is possible for the side edges of the substrate facing one another, due to the bending of the flexible heating element, to be formed so as to overlap or be spaced apart from one another. If the side edges facing one another are formed spaced apart from one another, a cylindrical shape with a longitudinal gap will be formed. The actual arrangement of the side edges facing one another can be designed variably depending on the later installation situation or on the basis of the field of application of the flexible heating element.

Furthermore, it is possible, if the flexible heating element is designed to be bent, to lock the flexible heating element in the bent shape by means of a fastening element. In other words, the flexible heating element may comprise a fastening element, wherein the bent shape of the flexible heating element is maintained by means of the fastening element.

In one embodiment of the invention, the fastening element can be formed in a flange-like manner. A flange-like fastening element can have the shape of a ring or a sleeve. The flange-like fastening element can be formed, for example, from metal or ceramic. These materials prove to be particularly temperature-stable. Due to the spring effect of the flexible heating element, it is particularly easy for the flexible heating element to fit snugly against the flange-like fastening element so as to enable a simple retention of the shape of the flexible heating element.

In a further embodiment of the invention, the fastening element can be designed in the manner of a cover. Such a cover or a cover-like fastening element is preferably arranged on at least one end of the formed hollow body, in particular of the formed cylinder. Preferably, a cover-like fastening element is pushed onto an end of the hollow body, in particular of the cylinder, so that the cover-like fastening element stabilizes the hollow body, in particular the cylinder.

In a further embodiment of the invention, it is possible to adapt or select the shape of the substrate of the flexible heating element in such a way that corresponding openings, in particular slots, are produced in the hollow body, in particular in the cylinder, in a bent state of the flexible heating element, i.e., during formation of a hollow body, in particular of a cylinder.

For example, it is possible for the substrate of the flexible heating element to comprise lateral recesses. For example, the substrate of the flexible heating element can have a meandering side-edge profile. The lateral recesses of the substrate of the flexible heating element can extend up to the middle of the substrate.

Furthermore, it is possible for lateral recesses of the substrate to be formed on opposite side-edges of the substrate such that they extend alternately up to the middle of the substrate or beyond the middle of the substrate.

In a further embodiment of the invention, it is possible for a bent flexible heating element, in particular of a hollow body type, in particular a cylindrical, flexible heating element, to be arranged in a sleeve. Such a sleeve can also be referred to as a cover sleeve. The sleeve is preferably made of metal, in particular aluminum or steel. Such a sleeve, in particular such a cover sleeve, protects the flexible heating element. In a preferred embodiment, the sleeve is electrically separated from the heating element or at least from the conductor track located on the heating element. In the preferred embodiment, the sleeve is heated via the heat flow via the mechanical contact between the heating element and the sleeve. In a particularly preferred embodiment, the bent heating element is pressed by its own spring force against the sleeve wall.

The flexible configuration permits an improved thermal contact between the flexible heating element and an object to be heated that has an uneven surface, and thus a rapid and energy-efficient heating of the object.

The formation of an insulation layer from the specified materials and with the indicated layer thicknesses enables rapid and energy-efficient heating of the substrate.

Due to the choice of material and/or layer thickness in connection with the flexible heating element, the heating element also has a low thermal mass so that a rapid and energy-efficient heating of the heating element is made possible.

A further aspect of the invention relates to a method for producing a flexible heating element according to the invention. With regard to individual method aspects, reference is made to the explanations in connection with the heating element according to the invention. Individual aspects with respect to producing the heating element are already contained within the preceding part of the description.

The method according to the invention for producing a heating element according to the invention comprises the steps of:
a) providing a substrate formed from a metal foil,
b) forming at least one insulation layer on at least one side of the substrate, and
c) applying a heating structure to the side of the insulation layer facing away from the substrate.

In step b), in order to form the insulation layer:
an anodized metal oxide layer is produced by means of an anodizing method or a hard anodization method,
or
an oxidation method is carried out at an oxidation temperature of at least 800° C.,
or
an aluminum layer is applied to at least one side of the substrate and then an aluminum oxide layer is produced by means of oxidation at temperatures of 800° C. to 1,200° C.,
or
an electrically insulating layer is applied to at least one side of the substrate by means of the ADM method or CVD method or CSD method or PVD method.

In step c), for applying the heating structure:
a structured metal element, in particular a structured metal foil element, is applied to the insulation layer,
or
the heating structure is formed on the insulating layer by means of thin-foil metal deposition,
or
the heating structure is formed on the insulating layer by printing a paste containing metal or an ink containing metal.

In a further embodiment of the method according to the invention, provision is made for a passivation layer to be applied to the heating structure at least in portions.

A passivation layer is preferably applied to the complete upper side of the heating structure. If the heating structure comprises contact pads, the contact pads are provided with a passivation layer at most in portions. Preferably, the contact pads are formed free of any passivation layer. This makes it possible to electrically contact the contact pads in a correspondingly simple manner.

The method according to the invention for producing a heating element is characterized by a particularly simple methodology and a cost-effective implementation.

In a further embodiment of the method according to the invention, steps a) to c) are carried out on a substrate strip and/or a substrate plate.

The forms of individual substrates are introduced onto the substrate strip and/or the substrate plate. For this purpose, the substrates are separated from the substrate strip and/or the substrate plate on the sides. The substrates are not detached from the substrate strip and/or the substrate plate at corners and/or individual side portions so that the individual substrates continue to be connected to the substrate strip and/or the substrate plate.

In this then present form, the individual substrates can be further processed so that steps b) and c) can be carried out together.

Finally, the individual substrates are separated from the substrate strip and/or the substrate plate.

The method according to the invention for producing a heating element according to the invention can also comprise step d). In step d), the substrate can be machined mechanically with regard to its shape. In step d), the substrate can be cut to shape and/or punched. Step d) can be carried out between steps b) and c).

Alternatively, it is possible for step d) to be carried out after step c). In other words, mechanical processing of the substrate can also be carried out after the application of a heating structure to the insulation layer. Such an embodiment of step d) is possible in particular when the insulation layer is formed from the substrate based on an oxidation method. In particular, this is possible if a thermal oxidation method or an anodizing method for producing the insulation layer is applied.

Due to the possibility of performing step d), it is possible to design the shape of the flexible heating element variably, wherein no restrictions exist to the effect that the shape must already be observed during the production of the substrate.

This simplifies the production of a heating element according to the invention.

A further aspect of the invention relates to the use of a flexible heating element according to the invention. The use according to the invention provides a use of the flexible heating element in combination with a temperature sensor and/or in combination with a temperature sensor chip and/or in an electrical smoking device.

It is possible to use the flexible heating element according to the invention as a temperature sensor. In such an application case, the resistance of the heating structure is measured, wherein the temperature to be measured can be detected by means of a temperature-resistance characteristic curve.

Furthermore, it is possible for the flexible heating element to comprise a temperature sensor. The temperature sensor can be arranged on the insulating layer of the flexible heating element. It is possible for the temperature sensor to take the form of a metal structure, in particular the form of a platinum structure.

Furthermore, it is possible for a temperature sensor chip to be formed integrated on and/or in the flexible heating element.

The heating element which is flexible according to the invention can be used particularly for heating and thermoregulating objects of any kind. This is due to the advantageous flexible and at the same time temperature-resistant design of the flexible heating element.

Particularly preferably, the flexible heating element can be used for rapidly heating flat articles with a small mass or of liquids or gases. In such a case, the flexible heating element can be pressed against the (flat) surface of the object to be heated in order to enable effective heat transfer. The force for pressing the heating element against its surroundings can also be based on the spring effect of a bent heating plate.

Due to the flat and flexible design of the flexible heating element, the heating element according to the invention can also be used in arrangements which should not be brought into contact with thick or rigid heating elements. The use of the flexible heating elements in cell packages, such as fuel cells or battery packs, can be cited as an example.

Furthermore, it is possible to apply the heating element according to the invention to electronic components such as semiconductors or sensors. Electronic components such as semiconductors or sensors can be heated to a desired operating temperature by means of the heating element according to the invention, and then the corresponding operating temperature can be maintained.

A further use of a flexible heating element according to the invention is the use in combination with textiles and/or clothing items.

Furthermore, the use of the flexible heating element as a heating head and/or heating strip for laminating or welding plastics materials is possible.

Furthermore, a flexible heating element according to the invention can be used in an electrical smoking device. It is preferably an electrical smoking device for combustion-free smoking of plant substances, such as tobacco, or organic liquids or alcoholic extracts. The liquids can be, for example, solutions containing nicotine.

If the electrical smoking device is to be used for combustion-free smoking of plant substances, plant materials are pressed into a pad and admixed with excipients such as glycerol. Such a pad is placed on a flexible heating element of the electrical smoking device and is pressed onto the flexible heating element due to a mechanical closure.

Due to the flexibility of the heating element, the heating element adapts to the surface shape of the pad and forms a good heat contact. The flexible heating element is electrically heated to temperatures of up to 300° C. to be able to extract the substances contained in the pad without combustion.

Because the flexible heating element comprises no polymers or other organic compounds, during heating of the flexible heating element no organic decomposition products are produced which are detrimental to inhalation of the aerosols produced.

If the electrical smoking device is used for combustion-free smoking of liquids, the liquid is transported from a reservoir in the direction of the surface of the flexible heating element and evaporates there. In particular, the liquid gets from the reservoir to the surface of the flexible heating element by means of a wick or a porous body.

In the following, according to Embodiments 1 to 5 different flexible heating elements and various methods for producing these flexible heating elements are specified.

### Embodiment 1

The flexible heating element comprises an electrically conductive substrate formed from an anodized aluminum foil. The substrate has a substrate thickness of 100 μm. The insulation layer is formed from the aluminum oxide layer. The insulation layer thickness is about 5 μm. The aluminum oxide layer exhibits a high electrical insulation between the surface of the oxide and the metal core of the metal foil. This applies in particular at low voltages.

The heating structure is formed from a metal foil, specifically a nickel-chromium (NiCr) foil. The heating element thickness is approximately 50 μm. The heating structure is designed such that a meander with a line width of 1 mm and a length of 50 mm is punched out of the nickel-chromium foil (specific resistance Ro=132 μΩ*cm). Contact pads are located at the respective ends of the heating structure, i.e., at the terminals. These contact pads have a width of 5 mm. An electrical resistance of 1.3Ω is present between the two contact pads.

After the heating structure is produced, the heating structure is placed on the side of the insulation layer (aluminum oxide layer) facing away from the substrate. The metal foil (aluminum foil) is then folded so that the heating structure is formed or arranged between two substrate portions. The heating structure is loose in a pocket of anodized aluminum foil and is freely displaceable within this pocket.

The structure thus present can be curved in order to fix the heating structure in the formed substrate pocket. Furthermore, due to the curvature, good heat transfer between the heating structure and the substrate is ensured.

### Embodiment 2

The structure of the substrate and the insulation layer corresponds to the structure according to Embodiment 1.

The heating structure is produced from an iron-nickel (FeNi) foil (Ro=72 μΩ*cm). The electrical resistance of the heating structure is consequently 0.72Ω. The advantage of such a material selection in connection with the heating structure is that iron-nickel has a high positive temperature coefficient of resistance, and consequently the heating structure has self-regulating properties.

This means that the electrical resistance of the heating structure increases with increasing temperature, and the heating structure is prevented from overheating.

### Embodiment 3

The substrate and the insulation layer are produced according to the structure described in Embodiment 1. The heating structure is produced by means of screen printing. For this purpose, a silver sinter paste is applied through a sieve to a side of the insulation layer facing away from the substrate. The silver sinter paste can furthermore comprise metal oxides and/or organic components and/or ground glass frit.

The silver sinter paste is subsequently baked at a temperature of approximately 400° C. Due to the use of a metal foil, in particular an aluminum foil, as an electrically conductive substrate, an application of such a temperature is possible.

### Embodiment 4

According to this embodiment, a so-called KAT sheet metal is used as the substrate. Such a sheet metal panel is formed from an iron-chromium aluminum (FeCrAl) alloy. To form an insulation layer, the KAT sheet metal is oxidized in air at over 1,000° C., in particular at 1,050 to 1,200° C. The edges of the sheet metal are thus also oxidized. The heating structure can then be applied to the insulation layer as a silver sinter paste.

### Embodiment 5

Embodiment 5 also provides for the use of a KAT panel. The individual substrates, which preferably have a rectangular shape, are separated from a blank consisting of a foil made of KAT sheet metal, without completely detaching them from the blank. Such an arrangement is produced by separating the individual substrates from the blank at their sides. At the corners, the individual substrates remain connected to the blank.

The substrates can be further processed in this arrangement, i.e., in the state connected to the blank. In particular, the anodization and the application of a heating structure to the individual substrates can take place in a single step for all substrates.

The separation of the substrates from the blank can be accomplished, for example, by means of punching and/or laser cutting.

The invention is explained in more detail below using exemplary embodiments with reference to the accompanying drawings.

In the drawings:

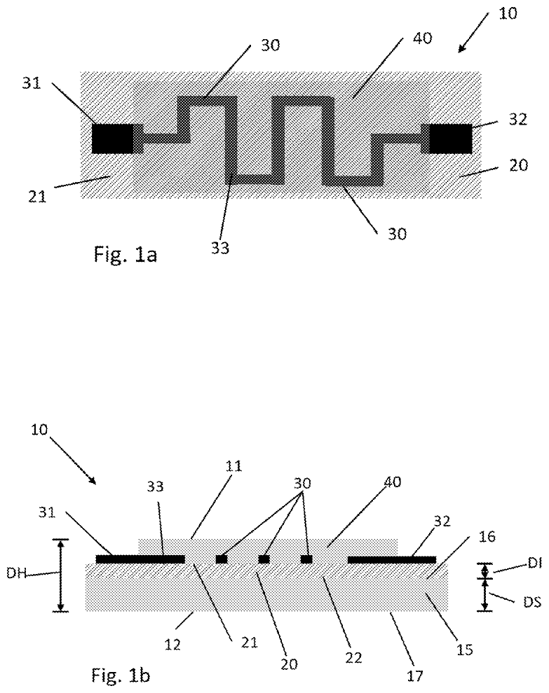

FIG. 1a is a plan view of a flexible heating element according to the invention;

FIG. 1b shows the flexible heating element in a side view; and

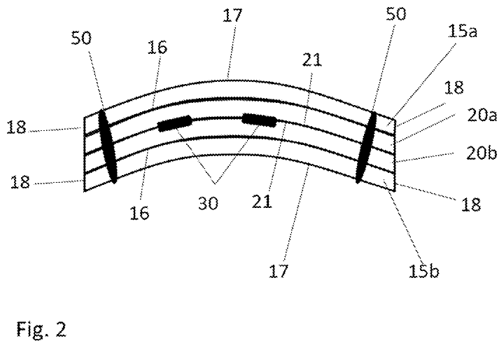

FIG. 2 shows a further embodiment with respect to a flexible heating element.

The flexible heating element 10 according to the invention substantially comprises five layers or elements.

The heating element 10 comprises a substrate 15, an insulation layer 20, a heating structure 30, contact pads 31 and 32, and a passivation layer 40.

The flexible heating element 10 has a temperature resistance of at least 250° C.

The electrically conductive substrate 15 is formed from a metal foil. The substrate comprises a first side 16, which faces upward, and a second side 17, which faces downward.

An insulation layer 20 is formed on the first side 16 of the substrate 15. The insulation layer 20 in turn has a first side 21 and a second side 22. The second side 22 rests on the substrate 15. The first side 21 of the insulation layer 20, by contrast, faces away from the substrate 15.

A heating structure 30 is formed on the side 21 of the insulation layer 20 facing away from the substrate 15. The heating structure 30 has a meandering shape. This heating structure 30 is preferably designed as a structured metal foil element. This metal foil element 30 can be applied to the first side 21 of the insulation layer 20.

A passivation layer 40 is additionally applied to the side 33 of the heating structure facing away from the substrate 15 or the insulation layer 20. Due to the meandering shape of the heating structure 30, the passivation layer 40 also reaches the portions of the side 21 of the insulation layer 20 that are not covered by a heating structure 30.

The heating structure 30 comprises contact pads 31 and 32 at both ends or is connected to these contact pads 31 and 32. The passivation layer 40 completely covers the heating structure. Furthermore, the contact pads 31 and 32 are partially covered by the passivation layer 40.

The heating element thickness DH shown is less than 1.0 mm. The substrate 15 has a substrate thickness DS of 0.02 mm to 0.5 mm. The insulation layer 20 has an insulation layer thickness DI of 0.2 μm to 30 μm.

The heating element 10 is flexibly designed, wherein the flexibility of the heating element 10 is defined as a relative deflection of the front side 11 or the rear side 12 of the heating element 10 at a bending radius of at least 30 mm, in particular of at least 25 mm, in particular of at least 20 mm, in particular of at least 10 mm, in particular of at least 0.5 mm.

The flexible heating element according to the invention is produced according to the following method steps:
a) First the substrate 15 formed from a metal foil is provided. The metal foils used are preferably foils made of materials which form dense metal oxide layers with a high electrical insulation during an anionic oxidation. Particularly suitable metal foils are foils made of aluminum, steel, titanium, niobium or tantalum. Alloys containing chromium and aluminum are particularly suitable as steel foils. These are, for example, FeCrAl alloys.
b) In this step, at least one insulation layer is formed on the first side 16 of the substrate 15. The insulation layer 20 is produced, for example, by anionic oxidation. Such an insulation layer 20 is an anodized metal oxide layer.
c) In this step, the heating structure 30 is applied to the side 21 of the insulation layer 20 facing away from the substrate 20. The heating structure 30 can be provided in an upstream method by producing a structured metal foil element. This can subsequently be applied to the side 21 of the insulation layer 20.

The contact pads 31 and 32 may be formed as a portion of the heating structure 30. Alternatively, it is possible for the contact pads 31 and 32 to be provided as separate elements or components.

It is possible, for example, for the contact pads 31 and 32 to be formed from sinter paste material. Such a sinter paste material is applied to the side 21 of the insulation layer 20. If the contact pads 31 and 32 are separate components, the heating structure 30 must be connected to the contact pads 31 and 32.

Finally, a passivation layer 40 is applied to the upwardly facing side 33 of the heating structure 30. The contact pads 31 and 32 are also partially coated with the passivation layer 40.

FIG. 2 shows an alternative embodiment with respect to a heating element 10. It can be seen that a heating element 10 may also comprise a plurality of substrate portions, namely a first substrate portion 15a and a second substrate portion 15b. The illustrated substrate portions 15a and 15b are formed separately from one another. The substrate portions 15a and 15b may be formed from different materials.

An insulation layer portion 20a or 20b is in turn formed on a first side 16 of each substrate portion 15a and 15b. The first sides 16 of the substrate portion are the inwardly facing sides. The second sides 17 of the substrate portions 15a and 15b each face outwardly and thus form the outer surfaces of the heating element.

FIG. 2 shows that the flexible heating element 10 can be bent. In particular, the heating element 10 can be bent further in such a way that the heating element 10 forms the shape of a cylindrical hollow body. Depending on the extent to which the side edges 18 of the substrate portions 15a and 15b are spaced apart from one another or, for example, are designed to be overlapping, the hollow body, in particular the cylindrical hollow body, can also comprise a slot-shaped recess.

The heating structure 30 is formed between the two insulation layer portions 20a and 20b. Based on the embodiment shown in FIG. 2, a type of sandwich arrangement of a heating element 10 is formed. The heating structure 30 is arranged in such a way by the electrically conductive substrate portions 15a and 15b that they do not lie one on top of the other or are not directly in electrical contact with one another.

The heating structure 30 is embedded between the insulation layer portions 20a and 20b in such a way that the insulation layer portions 20a and 20b each point toward one another on the first sides 21 or abut one another at least in portions.

The individual layers of the heating element 10 can, for example, be connected to one another by the weld spots 50 that are shown. A flexible heating element 10 as shown in FIG. 2 is particularly suitable for use in an electrical smoking device.

### LIST OF REFERENCE SIGNS

10 heating element
11 front side of heating element
12 rear side of heating element
15 substrate
15a, 15b substrate portions
16 first side of substrate
17 second side of substrate
18 side edge
20 insulation layer
20a, 20b insulation layer portions
21 first side of insulation layer
22 second side of insulation layer
30 heating structure
31 first contact pad
32 second contact pad
33 side of heating structure
40 passivation layer
50 weld spot
DH thickness of heating element
DS thickness of substrate
DI thickness of insulation layer

1. A flexible heating element exhibiting a temperature resistance of at least 250° C., in particular of at least 300° C., comprising:
an electrically conductive substrate formed from a metal foil,
an insulation layer formed on at least one side of the substrate, and
a heating structure formed on the side of the insulation layer facing away from the substrate,
wherein the heating element has a heating element thickness of less than 1.0 mm, the substrate has a substrate thickness of 0.02 mm-0.5 mm, and the insulation layer has an insulation layer thickness of 0.2 μm-30 μm.

2. The flexible heating element according to claim 1, wherein the insulation layer is a metal oxide layer, in particular an intrinsically grown or an anodized metal oxide layer, or a metal nitride layer or a metal oxide nitride layer.

3. The flexible heating element according to claim 2, wherein the insulation layer comprises aluminum oxide and/or aluminum titanate and/or titanium dioxide and/or silicon dioxide and/or silicon oxide and/or magnesium oxide and/or magnesium titanate and/or a binary zirconium dioxide alloy and/or a ternary zirconium dioxide alloy and/or boron nitride and/or aluminum nitride and/or silicon nitride.

4. The flexible heating element according to claim 1, wherein the insulation layer is produced by means of the aerosol deposition method.

5. The flexible heating element according to claim 1, wherein the flexibility of the heating element is defined as a reversible deflection of a front side or a rear side of the heating element at a bending radius of at least 30 mm, in particular of at least 25 mm, in particular of at least 20 mm, in particular of at least 10 mm, in particular of at least 0.5 mm.

6. The flexible heating element according to claim 1, wherein the metal foil is formed from aluminum and/or steel and/or titanium and/or niobium and/or tantalum or alloys thereof.

7. The flexible heating element according to claim 6, wherein the steel is a FeCrAl alloy, in particular X8CRAl20-5 or FeCr25Al5.

8. The flexible heating element according to claim 1, wherein the at least one heating structure is applied directly to the insulation layer.

9. The flexible heating element according to claim 1, wherein the at least one heating structure is formed between two substrate portions, the two substrate portions being formed by folding the substrate.

10. The flexible heating element according to claim 1, wherein the at least one heating structure has at least two contact pads or is connected to at least two contact pads, the at least two contact pads being formed on the side of the insulation layer facing away from the substrate.

11. A method for producing a heating element according to claim 1, comprising the steps of:
a) providing a substrate formed from a metal foil,
b) forming at least one insulation layer on at least one side of the substrate, and
c) applying a heating structure to the side of the insulation layer facing away from the substrate.

12. The method according to claim 11, wherein, in step b) in order to form the insulation layer,
an anodized metal oxide layer is produced by means of an anodizing method or a hard anodizing method, or
an oxidation method is carried out at an oxidation temperature of at least 800° C., or
an aluminum layer is applied on at least one side of the substrate and then an aluminum oxide layer is produced by means of oxidation at temperatures of 800° C.-1,200° C., or
an electrically insulating layer is applied to at least one side of the substrate by means of the ADM method or CVD method or CSD method or PVD method.

13. The method according to claim 11, wherein,
in step c) in order to apply the heating structure,
a structured metal element, in particular a structured metal foil element, is applied to the insulation layer, or
the heating structure is formed on the insulation layer by means of thin-foil metal deposition, or
the heating structure is formed on the insulation layer by printing a paste containing metal or an ink containing metal.

14. The method according to claim 11, wherein at least partially applying a passivation layer to the heating structure.

15. The use of a flexible heating element according to claim 1 in combination with a temperature sensor and/or in combination with a temperature sensor chip and/or in an electrical smoking device.
